(19) United States
(12) Patent Application Publication
(10) Pub. No.: US 2007/0129535 A1
(43) Pub. Date: Jun. 7, 2007

(54) Linear polyphosphonates and methods of making

(75) Inventors: Dieter Freitag, Chelmsford, MA (US); Michael A. Vinciguerra, Hampton, NH (US)

Correspondence Address: PEPPER HAMILTON LLP, ONE MELLON CENTER, 50TH FLOOR, 500 GRANT STREET, PITTSBURGH, PA, 15219, US

(73) Assignee: TRITON SYSTEMS, INC., Chelmsford, MA (US)

(21) Appl. No.: 10/546,669

(22) PCT Filed: Feb. 24, 2004
(86) PCT No.: PCT/US04/05443

§ 371 Date: May 24, 2006

Related U.S. Application Data
(63) Continuation-in-part of application No. 10/374,155, filed on Feb. 24, 2003, now abandoned.

(51) Int. Cl. C08G 79/02

(52) U.S. Cl. 528/398

(57) ABSTRACT

Disclosed are linear polyphosphonates produced by a transesterification process. These linear polyphosphonates exhibit a unique and advantageous combination of properties, such as outstanding fire resistance, unexpectedly high Tg's and good toughness at a low molecular weight. The favorable processing characteristics (such as low melt viscosity and excellent melt stability) of these linear polyphosphonates enable economic processing. Also disclosed are polymer compositions that comprise these linear polyphosphonates and at least one other polymer, wherein the resulting polymer compositions exhibit flame retardant properties.

### CROSS REFERENCE TO RELATED APPLICATIONS

This application claims the benefit and priority U.S. patent application Ser. No. 10/374,155 filed Feb. 24, 2003 which in incorporated herein by reference in its entirety.

### BACKGROUND

The production of linear, aromatic polyphosphonates by condensing aryl phosphonic acid dichlorides and aromatic diols in a solvent in the absence of a catalyst or in the presence of alkaline-earth metal halide catalysts is a known process and is described in several U.S. Patents (see e.g., U.S. Pat. Nos. 2,534,252; 3,946,093; 3,919,363 and 6,288,210 B1). The polyphosphonates are isolated from the solutions by precipitation into methanol or by evaporation of the solvent. This synthetic route typically leads to relatively low molecular weight polymers that exhibit poor toughness and poor melt stability. In addition, the polymer chains have halogen end-groups that can readily react with moisture to form hydrolysis products. This ultimately leads to breakdown of the molecular weight of the polymer and degradation of its mechanical properties, particularly toughness. Due to the reactive end-groups, these materials do not form stable melts and thus make processing problematic. The high temperatures required for melt processing typically causes a reduction in their molecular weight with consequent loss of mechanical properties, particularly toughness.

The use of these materials as fire or flame retardant additives for various plastics has been described in several U.S. Patents (see e.g., U.S. Pat. Nos. 3,719,727; 3,829,405; 3,830,771; 3,925,303 and 4,229,552). Such polyphosphonates are not useful as films or molded articles due to their low toughness, susceptibility to hydrolysis and melt instability. From an industrial viewpoint, such a synthetic method, condensing aryl phosphonic acid dichlorides and aromatic diols in a solvent, is undesirable because it requires the use of environmentally unfriendly solvents, such as methylene chloride, and leads to low molecular weight products with inferior properties that are sensitive to humidity, moisture, and high temperature. Further, the phosphonic acid dichlorides are hydrolytically sensitive and cannot be stored for long periods. Thus, these compounds require purification by distillation immediately prior to use. The overall effect of these issues and problems is the increase in the cost of production, which renders products that are not price or performance competitive in the marketplace.

Another synthetic approach in producing polyphosphonates has been the transesterification process. (see e.g., U.S. Pat. Nos. 2,682,522; 2,891,915 and 4,046,724). The transesterification process involves the reaction of a phosphonic acid diaryl ester, a bisphenol, and a basic catalyst carried out in the melt, usually in an autoclave. Transesterification is a chemical reaction that is an equilibrium between the starting materials (phosphonic acid diaryl ester and a bisphenol) and the products (polyphosphonate and phenol). The reaction is typically carried out at high temperature under reduced pressure. The by-product, phenol, is removed from the reaction by distillation; this helps shift the equilibrium toward polyphosphonate formation. One major problem with this process is that under the conditions of phenol removal, the phosphonic acid diaryl ester is also volatile and can co-distill with the phenol leading to stoichiometric imbalance and shifting of the equilibrium which leads to low molecular weight. This problem has been addressed by the placement of a distillation column in the process that allows for separation of the phenol from the phosphonic acid diaryl diester and condensation of the diester back into the reaction vessel. This approach has only achieved limited success because some of the phosphonic acid diaryl ester is still lost during the process, resulting in a low molecular weight product. Thus, the reaction conditions (temperature, time, and pressure), stoichiometric balance of the starting materials, and the amount of catalyst are critical parameters necessary to synthesize polyphosphonates having an acceptable combination of high T_{g}, good processing characteristics (i.e., low melt viscosity and good melt stability), and good toughness.

The transesterification process has so far failed to produce linear polyphosphonates of good processability and of sufficient molecular weight for toughness. In fact, much of the research and patents in this area have focused on the use of branching agents (tri and tetra functional phenols or phosphonic acid esters) (see e.g., U.S. Pat. Nos. 2,716,101; 3,326,852; 4,328,174; 4,331,614; 4,374,971; 4,415,719; 5,216,113; 5,334,692) or the use of copolymers (see e.g., U.S. Pat. Nos. 4,223,104; 4,322,520; 4,328,174; 4,401,802; 4,481,350; 4,508,890; 4,719,279; 4,762,905 and 4,782,123) as a means of increasing molecular weight and thereby toughness. These branched polyphosphonates lack toughness at a molecular weight suitable for easy melt processing, and high temperature melt processing causes their molecular weight to decrease.

### SUMMARY

There is a need for a method of producing linear polyphosphonates that have an advantageous combination of high T_{g}, toughness and processing characteristics. There is also a need for a method of synthesizing linear polyphosphonates without hydrolytically unstable or moisture absorbing end-groups.

An embodiment of the present invention is a method for producing linear polyphosphonates that possess good toughness and flame retardant properties at a low molecular weight by the transesterification route using specific molar ratios of a phosphonic acid diaryl ester, a bisphenol that is non-splitable or transesterification stable, and a catalyst. The method for producing these linear polyphosphonates includes heating at a reduced pressure a phosphonic acid diaryl ester, a transesterification stable bisphenol, and a transesterification catalyst in a vessel. The phosphonic acid diaryl ester is about 2 to 5 percent, preferably 2.1 to 2.8 percent, molar excess of the bisphenol, and the transesterification catalyst in an amount of at least about 0.001 mole of catalyst per one mole of bisphenol. The transesterification stable bisphenol dihydroxy aromatic compounds used in the method includes those represented by the structure (XV): 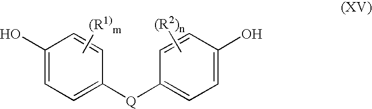
and combinations of these, wherein each (R¹)ₘ and (R²)ₙ can independently a hydrogen, halogen atom, nitro group, cyano group, C₁-C₂₀ alkyl group, C₄-C.₂₀ cycloalkyl group, or C₆-C₂₀ aryl containing group; m and n are independently integers 1-4; and Q may be a bond, oxygen atom, sulfur atom, or SO₂ group. The amount of transesterification catalyst can be the range of about 0.001 moles to about 0.005 moles per one mole of bisphenol in the vessel and may include but is not limited to sodium phenolate monohydrate, sodium phenolate dihydrate, sodium phenolate trihydrate, tetraphenylphosphonium phenolate, and combinations thereof. Preferably the catalyst is sodium phenolate monohydrate or tetraphenylphosphonium phenolate and the bisphenol includes 4,4′-dihydroxybiphenyl.

One embodiment of the present invention is a linear polyphosphonate composition that includes a phosphonic acid diaryl ester, a transesterification stable bisphenol, and a transesterification catalyst heated in a vessel at a reduced pressure whereby hydroxy aromatics are removed from the vessel to form the linear polyphosphonate. The amount of phosphonic acid diaryl ester used to form the linear polyphosphonate is about 2 to 5 percent molar excess of the bisphenol, and the transesterification catalyst is in an amount of at least about 0.001 mole of catalyst per one mole of bisphenol. The linear polyphosphonate formed has a relative viscosity greater than 1.1 at 23° C.

Another embodiment of the present invention is a composition that includes a flame retardant, linear polyphosphonates that exhibit an advantageous combination of Tg, toughness and processing characteristics (i.e., low melt viscosity) and commodity or engineering plastics. The composition may be prepared from at least one other plastic polymer and a linear polyphosphonate that is made by heating under a reduced pressure a transesterification stable bisphenol and a phosphonic acid diaryl ester which is about 2 to 5 percent molar excess of a the bisphenol, and a transesterification catalyst in an amount of at least about 0.001 mole of catalyst per one mole of bisphenol. The plastic polymer may a polycarbonate, polyacrylate, polyacrylonitrile, polyester, polyamide, polystyrene, polyurethane, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, polyether, polyphenylene oxide, cellulose polymer, branched polyphosphonates, or any combination thereof. Preferably the polymer plastic is a miscible thermoplastic polymer including but not limited to polystyrene and polyphenylene oxide, polycarbonate and poly(acrylonitrile butadiene styrene, or a polymer exhibits a limiting oxygen index of at least 27.

It is yet another object of the present invention to produce articles of manufacture from these linear polyphosphonates or from polymer compositions comprising these linear polyphosphonates. The article of manufacture may include at least one linear polyphosphonate prepared from a transesterification stable bisphenol, a phosphonic acid diaryl ester present from about 2 to 5 percent molar excess of a the bisphenol, and a transesterification catalyst in an amount of at least about 0.001 mole of catalyst per one mole of bisphenol. The article may be a fiber, a film, a coated substrate, a molding, a foam, a fiber reinforced article, or a combination these. The article may incldue a coating of the linear phosphonate applied to a portion of the article which may be a plastic, metal, ceramic, or wood product. The article may include polysilicone; polysiloxane; fluoropolymer; liquid crystalline polymer; polysilsesquioxane; polymers containing metal, ceramic, metal oxide, or carbon particles, polysiloxane filled with nanosilica, a polysiloxane filled with nanoalumina, a sol-gel silicate-type; or a combination these. Preferably the article includes a substrate that can be a polycarbonate, polyacrylate, polyacrylonitrile, polyester, polyamide, polystyrene, polyurethane, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, polyether, polyphenylene oxide, cellulose polymer, a branched polyphosphonate, or any combination these.

The present invention pertains to a method for producing linear polyphosphonates via a transesterification process, using a phosphonic acid diaryl ester, and a non-splitable transesterification stable bisphenol, and a transesterification catalyst at a specific molar ratio. This synthetic method yields flame retardant, linear polyphosphonates that exhibit an advantageous combination of high Tg, toughness and processing characteristics. This method involves placing 2 to 5 percent molar excess amount of a phosphonic acid diaryl ester (relative to the molar amount of bisphenol), a transesterification stable bisphenol which does react appreciably to form side product, not splitable, under the conditions of temperature and catalyst used to make the polyphopsphonate, and at least about 0.001 mole of catalyst (per one mole of bisphenol) into a reaction vessel and heating the mixture in the vessel under reduced pressure to a temperature where phenol begins to distill from the vessel. The heating of the reaction mixture may continue until the amount of phenol, catalyst, or other hydroxy aromatic distilled from the reaction vessel has decline to a level to produce a tough and processable linear polyphosphonate, preferably a polyphosphonate that is hydrolytically stable, or until the evolution of phenol has stopped.

### DESCRIPTION OF THE DRAWINGS

In part, other aspects, features, benefits and advantages of the embodiments of the present invention will be apparent with regard to the following description, appended claims and accompanying drawings where:

FIG. 1 graphically illustrates the isothermal behavior of linear polyphosphonate (Example 2) and branched polyphosphonates (Examples 3, 4 and 5) at 310° C. in nitrogen.

### DETAILED DESCRIPTION

Before the present compositions and methods are described, it is to be understood that this invention is not limited to the particular molecules, compositions, methodologies or protocols described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

“Optional” or “optionally” means that the subsequently described event or circumstance may or may not occur, and that the description includes instances where the event occurs and instances where it does not.

The present invention pertains to a method for preparing flame retardant, linear polyphosphonates having an advantageous combination of properties (T_{g}, toughness and processability) via a transesterification process by reacting phosphonic acid diaryl ester and a transesterification stable bisphenol in the presence of a catalyst. The terms “flame retardant”, “flame resistant”, “fire resistant” or “fire resistance”, as used herein, mean that the polymer exhibits a limiting oxygen index of at least 27.

The transesterification reaction is conducted at a high temperature in the melt under a reduced pressure. The reaction temperature and pressure can be adjusted at several stages during the course of the reaction. The temperature may be changed during the reaction within this range without limitation. While the volatile hydroxy aromatic compounds such as phenol are distilled off at elevated temperature, preferably at a reduced pressure which can include a purge of inert gas, the reaction is continued until the required degree of condensation is reached which may be indicated by a decrease or cessation of evolved reaction products. The pressure of the reaction vessel is chosen to aid in the removal of volatile reaction products, excess reagents, and a polymerization catalyst, preferably a removable phosphonium catalyst, from the vessel. Without limitation the pressure may be chosen to accomplish this effect and may range from above atmospheric pressure to below atmospheric pressure. Preferably at any time during the reaction process, the vessel pressure include pressure in the range from about 760 mm Hg to about 0.3 mm Hg or less. The reaction time depends upon a number of factors including but not limited to the temperature, concentration, removal of reactants from the vessel, and or the inclusion of additional heating and catalyst additions. Generally the reaction is completed when excess reagents and volatile reaction products are removed from the vessel in an amount to provide a linear polyphosphonate.

The melt polymerization may be accomplished in one or more stages, as is known in the art with other polymerization catalysts. The polymerization catalyst and any co-catalysts may be added together in the same stage or at different stages. The polymerization catalyst may be added in a continuous or semi-continuous manner to the vessel where one or more stages of the process are combined to form a single stage process. The melt polymerization to form the polyphosphonates of the present invention may be a batch or continuous flow process.

The stoichiometric ratio (i.e., molar ratio) of the phosphonic acid diaryl ester to the bisphenol and the concentration of the catalyst are important aspects of this invention. A non-stoichiometric ratio of from about 2 to about 5 mole percent excess of the phosphonic acid diaryl ester is preferred, with from about 2 to about 3.5 mole percent of the phosphonic acid diaryl ester being more preferred, and with from about 2.1 to about 2.8 mol percent of the phosphonic acid diaryl ester being most preferred. Control of the amount of catalyst is desirable in order to obtain polymer of sufficient molecular weight to exhibit good toughness and also to be essentially free of hydroxy or phenolate end-groups, which is important for both melt stability and hydrolytic stability. The term “good toughness”, as used herein, means that a specimen molded from the polymers of the present invention exhibit fracture energy that is much better than that of a specimen prepared from other polyphosphonates, as shown herein via examples 1 and 2 versus examples 3, 4 and 5.

The methods of the present invention allow for the use of phosphonic acid diaryl esters having purities less than 98%. The ability to use lower purity monomer is a major advantage because it mitigates the need for additional purification steps, which contributes to cost reduction. By following the methods of the present invention, linear polyphosphonates at a low molecular weight, essentially free of hydroxyl or phenolate end-groups, exhibiting good toughness and flame retardant properties are obtained. The presence of hydroxyl or phenolate end groups can be determined using FTIR spectroscopy. The term “low molecular weight”, as used herein, means that the polymer exhibits a relative viscosity of about 1.0 to about 1.20 when measured on a 0.5% weight/volume solution in methylene chloride solution at 23° C. These linear phosphonates possess outstanding flame resistance, an advantageous combination of high Tg, desired melt processing characteristics (such as low melt viscosity and excellent melt stability), and good toughness.

The catalyst is incorporated at least about 0.001 mole (per one mole of bisphenol), with the range of about 0.001 to about 0.005 moles per one mole of bisphenol being the preferred amount. The combination of the catalyst concentration and the excess concentration of the phosphonic acid diaryl ester is an important aspect of this invention.

A phosphonium catalyst is preferred. Tetraphenylphosphonium catalyst derivatives associated with an anion, are preferably for use herein. Example of preferred anions include tetraaryl borohydride, halide, and substituted or unsubstitured phenolate group (commercially available from, for example, Fisher Sceintific, Pittsburgh Pa.; a sigma Aldrich respectively). Most preferred catalyst for use herein is tetraphenylphosphonium phenolate. This catalyst has the added advantage that under the reaction conditions, its reacts to form volatile byproducts that are removed by distillation under the reduced pressure conditions of the reaction. Thus, no residual metal containing catalyst is left in the polymer. Residual metals or metal ions in organic polymers can catalyze their thermal or hydrolytic degradation. Thus the linear polyphosphonate described herein exhibit improved thermal and hydrolytic stability compared to other reported linear polyphosphonates.

The methods of the present invention for synthesizing linear polyphosphonates can be used with nearly any combination of a phosphonic acid diaryl ester, a transesterification stable bisphenol and a catalyst, preferably a basic catalyst.

Phosphonic acid diaryl esters or mixtures of them used for making linear polyphosphonates of the present invention include those of formula (XIII): 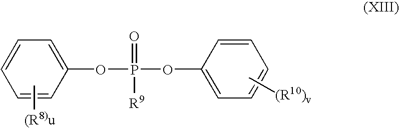
wherein each (R⁸)ᵤ and (R¹⁰)ᵥ can independently be a hydrogen, lower alkyl of C₁-C₄, the integers u and v can be 1-5; R⁹ can be lower alkyl C₁-C₄. In preferred embodiments, the phosphonic acid diaryl ester includes methyl-phosphonic acid diphenyl ester or methyldiphenoxyphosphine oxide where R⁹ is a methyl radical.

This synthetic method can be used with any transesterification stable bisphenol. One skilled in the art could test or screen for such compounds by using standard reaction condition such as catalyst, phosphonic diaryl ester, and various bisphenols and examining for bisphenol degradation products. Preferably the bisphenol does not degrade to products, such as isopropenyl phenol, which can lead to branching reactions. These transesterification stable dihydroxy aromatic compounds may be but are not limited to those represented by the structure (XV) 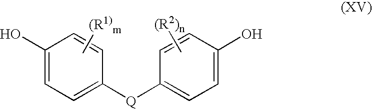
and combinations of these, wherein each (R¹)ₘ and (R²)ₙ can independently be a hydrogen, a halogen atom, nitro group, cyano group, C₁-C₂₀ alkyl group, C₄-C.₂₀ cycloalkyl group, or C₆ -C₂₀ aryl containing group; m and n are independently integers 1-4; and Q may be a bond, oxygen atom, sulfur atom, or SO₂ group.

Preferred transesterification stable bisphenols for use herein include but are not limited to 4,4′-dihydroxybiphenyl; 4,4′-dihydroxybiphenyl sulfone, 4,4′-dihydroxybiphenyl sulfide, 4,4′-dihydroxybiphenyl ether, the structure of formula (III) wherein each (R¹)ₘ and (R²)ₙ can be hydrogen or lower alkyl and m and n are integers 1-3, and combinations of these. Such bisphenols are commercially available from, for example, Sigma-Aldrich Co., Milwaukee, Wis.; Biddle Sawyer Corp., New York, N.Y.; and Reichold Chemicals, Inc., Research Triangle Park, N.C., or can be made using literature procedures. Copolymers prepared using two or more of any combination of transesterification stable bisphenols may also be prepared by the methods of the present invention.

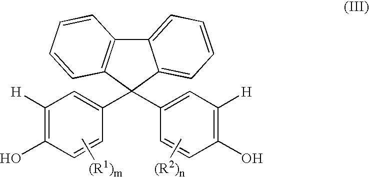

This method of synthesizing linear polyphosphonates is compatible with a variety of catalysts, such as alkaline metal phenolate derivatives, nitrogen containing phenolate derivatives and phosphorus containing phenolate derivatives. The reaction for making the linear polyphosphonates of the present invention is show schematically in Scheme (I). A preferred alkaline metal phenolate derivative is sodium phenolate. A more preferred alkaline metal phenolate derivative is sodium phenolate monohydrate. A preferred nitrogen-containing phenolate derivative is ammonium phenolate. (These various phenolates are commercially available from, for example, Sigma-Aldrich). A preferred phosphorus containing phenolate derivative is tetraphenyl phosphonium phenolate.

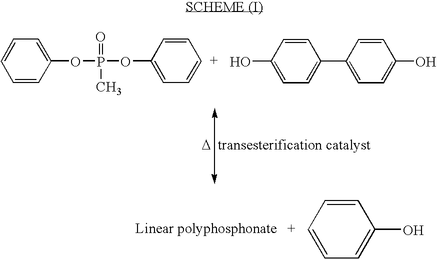

It is contemplated that linear polyphosphonates or the polymer compositions of the present invention may comprise other components, such as fillers, surfactants, organic binders, polymeric binders, crosslinking agents, coupling agents, anti-dripping agents, colorants, inks, dyes, or any combination thereof.

The linear polyphosphonates of the present invention can also be used to produce polymer compositions. The term “polymer composition”, as used herein, refers to a composition that comprises at least one linear polyphosphonate of the present invention and at least one other polymer. There term “other polymer”, as used herein, refers to any polymer other than the linear phosphonates of the present invention. These other polymers may be commodity or engineering plastics. Examples of these other polymers include polycarbonate, polyacrylate, polyacrylo-nitrile, polyester, polyamide, polystyrene (including high impact strength polystyrene), polyurethane, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, cellulose polymer, branched polyphosphonates, or any combination thereof (commercially available from, for example, GE Plastics, Pittsfield, Mass.; Rohm & Haas Co., Philadelphia, Pa.; Bayer Corp.-Polymers, Akron, Ohio; Reichold DuPont, Wilmington, Del.; Huntsman LLC, West Deptford, N.J.; BASF Corp., Mount Olive, N.J.; Dow Chemical Co., Midland, Mich.; GE Plastics; DuPont; Bayer; Dupont; ExxonMobil Chemical Corp., Houston, Tex.; ExxonMobil; Mobay Chemical Corp., Kansas City, Kans.; Goodyear Chemical, Akron, Ohio; BASF Corp.; 3M Corp., St. Paul, Minn.; Solutia, Inc., St. Louis, Mo.; DuPont; and Eastman Chemical Co., Kingsport, Tenn., respectively). The polymer composition may be produced via blending, mixing, or compounding the constituent polymers. The linear polyphosphonate of the present invention impart flame retardant properties to the resulting polymer compositions.

The linear polyphosphonates of the present invention may be applied as coatings, particularly fire retardant coatings, to the surface of articles. The linear polyphosphonates of the present invention can be used as coatings on plastics, metals, ceramics, or woodproducts or they can be used to fabricate free-standing films, fibers, foams, and molded articles.

Coatings may be applied to the linear polyphosphonates. Examples of such preferred coating materials include polysilicones; polysiloxanes; polyoxysilsesquioxanes; fluoropolymers; liquid crystalline polymers; polymers containing metal, ceramic, metal oxide, or carbon particles, or any combination thereof; and sol-gel silicate-type; or any combination thereof (commercially available from, for example, Witco Chemical Corp., Greenwich, Conn.; Rhodia Silicones, Cranbury, N.J.; Gelest Inc., Morrisville, Pa.; Celanese AG, Dallas, Tex.; DuPont; and SDC Coatings, Inc., Anaheim, Calif., respectively). An example of a more preferred coating material is a polysiloxane that contains nanosilica and/or nanoalumina. The coatings can be applied by dip-coating, spraying, vacuum deposition, or other commonly used coating methods. A drying step may follow the application of the coating.

The linear polyphosphonates produced via the synthetic method of the present invention are self-extinguishing in that they immediately stop burning when removed from a flame. Any drops produced by melting these linear polyphosphonates in a flame instantly stop burning and do not propagate fire to any surrounding materials. Moreover, these linear polyphosphonates do not evolve any noticeable smoke when a flame is applied. Accordingly, these linear polyphosphonates can be used as additives in commodity or engineering plastics to significantly improve fire resistance without severely degrading their other properties, such as toughness or processing characteristics.

The linear polyphosphonates of the present invention exhibit outstanding flame resistance and, a more advantageous combination of high Tg, toughness and processing characteristics, as compared to the state-of-the-art branched polyphosphonates of comparable molecular weight. These property improvements make the linear polyphosphonates of the present invention useful in applications requiring outstanding fire retardancy, high temperature performance, impact resistance, and the ability to be readily melt processed with negligible degradation. The method for synthesizing these linear polyphosphonates offers reduced complexity because it does not require a branching agent and requires less pure starting materials than the state-of-the-art methods. These features are important for reducing production costs.

The relationship and usefulness of solution viscosity as a measure of polymer molecular weight has been recognized since the 1930s. Solution viscosity is a measure of the size or extension in space of polymer molecules, it is empirically related to molecular weight. The simplicity of the measurement and the usefulness of the solution viscosity-molecular weight correlation are so great that viscosity measurement constitutes an extremely valuable tool for the molecular characterization of polymers. It is further recognized that lower molecular weight is indicative of lower melt viscosity, and low melt viscosity facilitates easy and cost-effective processing of polymers.

The limiting oxygen index (LOI) of a material is indicative of its ability to burn once ignited. This test for LOI is performed according to a procedure set forth by the American Society for Test Methods (ASTM). The test, ASTM D2863, provides quantitative information about a material's ability to burn or “ease of burn”. If a polymeric material has an LOI of at least 27, it will, generally, burn only under very high applied heat.

Various aspects of the present invention will be illustrated with reference to the following non-limiting examples.

### EXAMPLE 1

This example describes the synthesis of linear polyphosphonate prepared using the methods and materials of the present invention.

A 250 mL, three neck round bottom flask equipped with a mechanical stirrer, a distillation column (10 cm) filled with hollow glass cylinders, a condenser, and a vacuum adapter with control valve was flushed with nitrogen for 0.5 hour. Methyldiphenoxyphosphine oxide (38.15 g)—because this compound is 97.22% pure as determined by high performance liquid chromatography (HPLC)—the precise amount of this compound is actually (37.09 g, 0.1495 moles), 4,4′-dihydroxybiphenyl (27.15 g, 0.1460 moles), and sodium phenolate monohydrate (0.022 g, 1.64×10⁻⁴ moles, 0.0011 mole per one mole of bisphenol) were placed into the flask and the flask was flushed with nitrogen again. (This is an excess of 2.4 percent in the number of moles of methyldiphenoxyphosphine oxide relative to the molar amount of bisphenol). The distillation column was wrapped with heating tape and heated. The reaction vessel was placed in an oil bath. The reaction mixture was heated and the vacuum was adjusted at various times during the reaction as indicated in Table I.

TABLE I
REACTION PARAMETERS

| Time after starting | Oil Bath Temp. | Vapor Temp. | Vacuum |
|---|---|---|---|
| (minutes) | (° C.) | (° C.) | (mm Hg) |
| 45 | 245 | 27 | 760 |
| 60 | 247 | 27 | 136 |
| 75 | 241 | 105 | 127 |
| 120 | 246 | 92 | 123 |
| 150 | 244 | 90 | 122 |
| 180 | 245 | 96 | 123 |
| 210 | 249 | 85 | 85 |
| 240 | 246 | 85 | 81 |
| 255 | 258 | 105 | 80 |
| 270 | 260 | 85 | 13 |
| 295 | 284 | 87 | 13 |
| 360 | 292 | 41 | 0.10 |
| 390 | 303 | 40 | 0.10 |
| 420 | 312 | 170 | 0.11 |
| 450 | 313 | 173 | 0.11 |
| 495 | 313 | 168 | 0.11 |
| 510 | 311 | 166 | 0.11 |
| 540 | 312 | 168 | 0.11 |
| 570 | 304 | 175 | 0.11 |
| 600 | 307 | 177 | 0.10 |
| Stopped | Stopped | Stopped | Stopped |

During the course of this reaction 28.5 g of distillate was collected. At the end of the reaction there was an increase in the viscosity of the polymer melt. Upon cooling, the viscous, light yellow melt began to solidify. After further cooling to room temperature, the flask was broken to isolate the solid. The solid polymer could not be cracked or broken with a hammer. It was so tough that it had to be removed from the stirring shaft with a saw. A 0.5% solution of the polymer in methylene chloride exhibited a relative viscosity of 1.17 at 23° C. A film was cast, in accordance to common casting methods, from a methylene chloride/polymer solution onto plate glass and subsequently thermally treated to remove the solvent. The film was transparent, tough, flexible, colorless, and exhibited a Tg of 135° C. It should be noted that the reaction temperature was held at slightly above 300° C. for more than about 3.5 hours. During this time, no decrease in the melt viscosity was observed.

A plaque was fabricated from this polymer via compression molding. This plaque was subjected to a burn test by placing the plaque directly in the flame of a propane torch. The plaque first softened and then melted due to its thermoplastic nature. Drops of molten plastic that dripped from the plaque immediately self-extinguished once they were out of the direct flame. In addition, the drops did not spread or propagate the fire to any surrounding materials. The plaque also stopped burning immediately upon removal of the flame. During this test, no smoke evolved from the plaque while it was in the flame or after the flame was removed. This test demonstrates the outstanding flame retardant characteristics of this linear polyphosphonate and, most importantly, its ability to self-extinguish. These properties are critical for applications requiring fire resistance.

### EXAMPLE 2

This example illustrates the synthesis of a linear polyphosphonate

A 250 mL, three neck round bottom flask equipped with a mechanical stirrer, a distillation column (10 cm) filled with hollow glass cylinders, a condenser, and a vacuum adapter with control valve was flushed with nitrogen for 0.5 hour. Methyldiphenoxyphosphine oxide (38.87 g)—because this compound is 95.41% pure as determined by HPLC—the precise amount of this compound is actually (37.09 g, 0.1495 moles), 4,4′-dihydroxybiphenyl (27.15 g, 0.1460 moles) and sodium phenolate monohydrate (0.022 g, 1.64×10⁻⁴ moles, 0.0011 mole per one mole of bisphenol) were placed into the flask and the flask was flushed with nitrogen again. (This is an excess of 2.4 percent in the number of moles of methyldiphenoxyphosphine oxide relative to the molar amount of bisphenol). The distillation column was wrapped with heating tape and heated. The reaction vessel was placed in an oil bath. The reaction was conducted under the conditions described for Example 1.

At the end of the reaction, there was an increase in the viscosity of the polymer melt. Upon cooling, the viscous, light yellow melt began to solidify. After further cooling to room temperature, the flask was broken to isolate the solid. The solid polymer could not be cracked or broken with a hammer. It was so tough that it had to be removed from the stirring shaft with a saw. A 0.5% solution of the polymer in methylene chloride exhibited a relative viscosity of 1.11 at 23° C. A film was cast from a methylene chloride/polymer solution onto plate glass and subsequently thermally treated to remove the solvent. The resulting film was transparent, tough, flexible, colorless, and exhibited a Tg of 135° C. It should be noted that the reaction temperature was held at slightly above 300° C. for more than about 3.5 hours. During this time, no decrease in the melt viscosity was observed.

### EXAMPLE 3

This example illustrates a state-of-the-art comparative example (Branched Polyphosphonate)

A branched polyphosphonate was prepared in accordance to U.S. Pat. Nos. 4,331,614 and 4,415,719 for the purpose of comparing with the linear polyphosphonates of the present invention. The molar excess of the bisphenol (4,4′-dihydroxydiphenyl, 29.76 g, 0.16 mole) to the phosphonic diester (38.19 g, 0.154 mole) was 3.8 mole %. The amount of sodium phenolate monohydrate used (0.002 g, 1.5×10⁻⁵ moles) was 9.4×10⁻⁵ moles relative to one mole of bisphenol, and (0.15 g, 5.0×10⁻⁴ moles) of the trihydroxy derivative (i.e., branching agent) was used. The polymer was isolated; it exhibited some toughness, but not as tough as the polymers described in Examples 1 and 2. A 0.5% solution of the polymer in methylene chloride exhibited a relative viscosity of 1.11 at 23° C. A film was cast from a methylene chloride/polymer solution onto plate glass and subsequently thermally treated to remove the solvent. The resulting film was brittle and slightly yellow in color and exhibited a Tg of 122° C.

### EXAMPLE 4

This example illustrates a state-of-the-art comparative example (Branched Polyphosphonate).

A branched polyphosphonate was prepared in accordance to U.S. Pat. Nos. 4,331,614 and 4,415,719 for the purpose of comparing with the linear polyphosphonates of the present invention. The molar excess of the phosphonic diester (40.01 g, 0.1613 mole) to the bisphenol (4,4′-dihydroxydiphenyl, 29.76 g, 0.16 mole) was 0.8 mole %. The amount of sodium phenolate monohydrate used (0.002 g, 1.5×10⁻⁵ moles) was 9.4×10⁻⁵ moles relative to one mole of bisphenol, and (0.15 g, 5.0×10⁻⁴ moles) of the trihydroxy derivative (i.e., branching agent) was used. The polymer was isolated; it exhibited some toughness, but not as tough as the polymers described in Examples 1 and 2. A 0.5% solution of the polymer in methylene chloride exhibited a relative viscosity of 1.15 at 23° C. A film was cast from a methylene chloride/polymer solution onto plate glass and subsequently thermally treated to remove the solvent. The resulting film was brittle and slightly yellow in color and exhibited a Tg of 115° C.

### EXAMPLE 5

This example illustrates a state-of-the-art comparative example (Branched Polyphosphonate)

A branched polyphosphonate was prepared in accordance to U.S. Pat. Nos. 4,331,614 and 4,415,719 for the purpose of comparing with the linear polyphosphonates of the present invention. The molar excess of the phosphonic diester (41.9 g, 0.169 mole) to the bisphenol (4,4′-dihydroxydiphenyl, 29.76 g, 0.16 mole) was 5.6 mole %. The amount of sodium phenolate monohydrate used (0.004 g, 3.0×10⁻⁵ moles) was 1.9×10⁻⁴ moles relative to one mole of bisphenol, and (0.025 g, 8.16×10⁻⁵ moles) of the trihydroxy derivative (i.e., branching agent) was used. The polymer was isolated; it exhibited some toughness, but not as tough as the polymers described in Examples 1 and 2. A 0.5% solution of the polymer in methylene chloride exhibited a relative viscosity of 1.11 at 23° C. A film was cast from a methylene chloride/polymer solution onto plate glass and subsequently thermally treated to remove the solvent. The film was brittle and slightly yellow in color and exhibited a Tg of 118° C.

### EXAMPLE 6

This example makes a comparative analysis of the thermal stability of linear polyphosphonate of example 2 and branched polyphosphonates of examples 3, 4 and 5.

Samples of each polyphosphonate [Example 2 (linear polyphosphonate), Examples 3, 4 and 5 (branched polyphosphonates)] were dried in a vacuum oven at 100° C. for approximately 16 hours. They were subsequently placed in a thermogravimetric analyzer (TA Instruments, Model 2950), and heated to 310° C. under a nitrogen atmosphere and held for 50 minutes. The weight loss (in percent) was monitored as a function of time at this temperature. The linear polyphosphonate of Example 2 exhibited very little weight loss over the 50 minute exposure time (only about 0.5%). The comparative state-of-the-art examples 3, 4 and 5 (the branched polyphosphonates) having comparable relative viscosities (i.e., comparable molecular weight) exhibited a higher weight loss, losing more than 1.5% of their original weight. The weight loss curves for Examples 3 and 4 are indistinguishable and lie on top of each other.

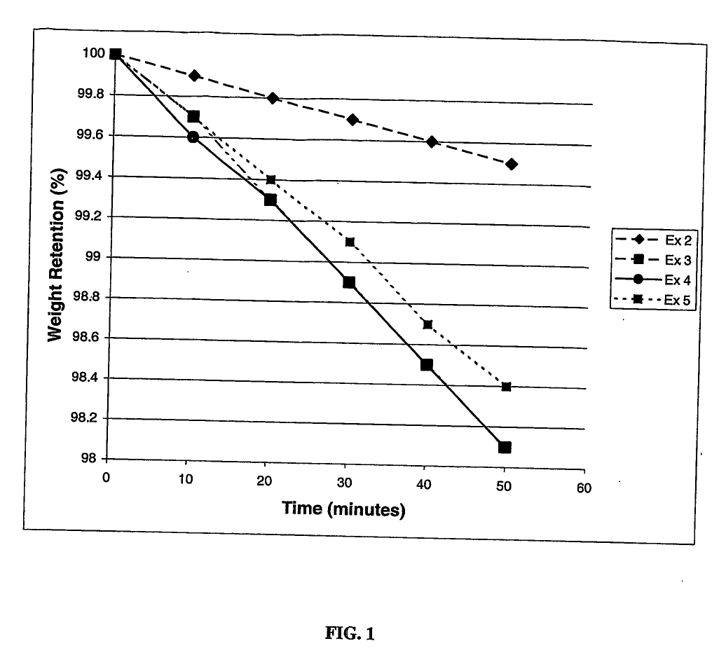

This experiment demonstrates that the linear polyphosphonates prepared in accordance to the method of the present invention exhibit improvements in thermal stability (which relates to melt stability and processing characteristics) and melt stability relative to state-of-the-art branched polyphosphonates. The weight loss curves of the linear polyphosphonate (Example 2), and the branched polyphosphonates (Examples 3, 4 and 5) at 310° C. in nitrogen are presented in FIG. 1.

Although the present invention has been described in considerable detail with reference to certain preferred embodiments thereof, other versions are possible. Therefore the spirit and scope of the appended claims should not be limited to the description and the preferred versions contain within this specification.

What is claimed is:

1. A method for producing linear polyphosphonates, comprising:
heating at a reduced pressure a phosphonic acid diaryl ester, a transesterification stable bisphenol, and a transesterification catalyst in a vessel, wherein said phosphonic acid diaryl ester is about 2 to 5 percent molar excess of a the bisphenol, and said transesterification catalyst in an amount of at least about 0.001 mole of catalyst per one mole of bisphenol.

2. The method of claim 1, wherein said phosphonic acid diaryl ester is about 2.1 to 2.8 percent molar excess of a the bisphenol.

3. The method of claim 1, wherein said transesterification stable bisphenol dihydroxy aromatic compounds includes those represented by the structure (XV): 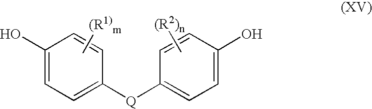
and combinations of these, wherein each (R¹)ₘ and (R²)ₙ can independently be hydrogen, a halogen atom, nitro group, cyano group, C₁-C₂₀ alkyl group, C₄-C.₂₀ cycloalkyl group, or C₆-C₂₀ aryl containing group; m and n are independently integers 1-4; and Q may be a bond, oxygen atom, sulfur atom, or SO₂ group.

4. The method of claim 1, wherein the amount of transesterification catalyst is in the range of about 0.001 moles to about 0.005 moles per one mole of bisphenol in the vessel.

5. The method of claim 1, wherein the transesterification catalyst is selected from the group consisting of sodium phenolate monohydrate, sodium phenolate dihydrate, sodium phenolate trihydrate, tetraphenylphosphonium phenolate, and combinations thereof.

6. The method of claim 1, wherein the catalyst is sodium phenolate monohydrate.

7. The method of claim 1, wherein the catalyst is tetraphenylphosphonium phenolate.

8. The method of claim 1, wherein the bisphenol includes 4,4′-dihydroxybiphenyl.

9. A composition comprising:
a phosphonic acid diaryl ester, a transesterification stable bisphenol, and a transesterification catalyst heated in a vessel at a reduced pressure whereby hydroxy aromatics are removed from the vessel, wherein said phosphonic acid diaryl ester is about 2 to 5 percent molar excess of the bisphenol, and said transesterification catalyst is in an amount of at least about 0.001 mole of catalyst per one mole of bisphenol.

10. The composition of claim 9, wherein the linear polyphosphonate has a relative viscosity greater than 1.1 at 23° C.

11. A composition, comprising:
at least one linear polyphosphonate prepared from a phosphonic acid diaryl ester, a transesterification stable bisphenol, and a transesterification catalyst heated in a vessel at a reduced pressure whereby hydroxy aromatics are removed from the vessel, wherein said phosphonic acid diaryl ester is about 2 to 5 percent molar excess of a the bisphenol, and said transesterification catalyst in an amount of at least about 0.001 mole of catalyst per one mole of bisphenol; and
at least one other polymer.

12. The composition of claim 11, wherein the polymer is a polycarbonate, polyacrylate, polyacrylonitrile, polyester, polyamide, polystyrene, polyurethane, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, polyether, polyphenylene oxide, cellulose polymer, branched polyphosphonates, or any combination thereof.

13. The composition of claim 11 wherein the other polymer is a miscible thermoplastic polymer.

14. The composition of claim 11, wherein the polymer includes polystyrene and polyphenylene oxide.

15. The composition of claim 11, wherein the other polymer includes polycarbonate and poly(acrylonitrile butadiene styrene).

16. The composition of claim 11, wherein the other polymer exhibits a limiting oxygen index of at least 27.

17. An article of manufacture comprising:
at least one linear polyphosphonate prepared from a phosphonic acid diaryl ester, a transesterification stable bisphenol, and a transesterification catalyst heated in a vessel at a reduced pressure whereby hydroxy aromatics are removed from the vessel, wherein said phosphonic acid diaryl ester is about 2 to 5 percent molar excess of a the bisphenol, and said transesterification catalyst in an amount of at least about 0.001 mole of catalyst per one mole of bisphenol.

18. The article of claim 17, wherein the article is a fiber, a film, a coated substrate, a molding, a foam, a fiber reinforced article, or a combination thereof.

19. The article of claim 17, wherein the article comprises a coating of said linear phosphonate applied to a portion of the article.

20. The article of claim 19, wherein the coating further comprises polysilicone; polysiloxane; fluoropolymer; liquid crystalline polymer; polysilsesquioxane; polymers containing metal, ceramic, metal oxide, or carbon particles, polysiloxane filled with nanosilica, a polysiloxane filled with nanoalumina, a sol-gel silicate-type; or a combination thereof.

21. The article of claim 19 wherein the article is a substrate including is a polycarbonate, polyacrylate, polyacrylonitrile, polyester, polyamide, polystyrene, polyurethane, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, polyether, polyphenylene oxide, cellulose polymer, a branched polyphosphonate, or any combination thereof.
